(19) United States
(12) Patent Application Publication
(10) Pub. No.: US 2022/0306132 A1
(43) Pub. Date: Sep. 29, 2022

(54) MOBILE OBJECT CONTROL SYSTEM, MOBILE OBJECT, AND CONTROL METHOD

(71) Applicant: HONDA MOTOR CO.,LTD., Tokyo (JP)

(72) Inventor: Takayuki SEKI, Saitama (JP)

(21) Appl. No.: 17/589,906

(22) Filed: Feb. 1, 2022

(30) Foreign Application Priority Data
Mar. 23, 2021 (JP) 2021-048657

(51) Int. Cl. B60W 50/029; B60W 50/02

(52) U.S. Cl. CPC B60W 50/029; B60W 50/0205; B60R 16/03

(57) ABSTRACT

Provided is a mobile object control system mounted on a mobile object in which driver assistance control is executed based on information on a to-be-monitored object, comprising a first control system including a first processor configured to acquire information from at least one or more first sensors and to calculate first information on a to-be-monitored object from the acquired information, where the first control system can deliver a calculation result of the first information to a second control system, where the second control system includes a second processor configured to acquire information acquired from at least one or more second sensors different from the first sensors and to calculate second information on a to-be-monitored object based on the calculation result delivered from the first control system and information acquired from the second sensors.

The contents of the following Japanese patent application(s) are incorporated herein by reference: NO. 2021-048657 filed in JP on Mar. 23, 2021.

### BACKGROUND

### 1. Technical Field

The present invention relates to a mobile object control system, a mobile object, and a control method.

### 2. Related Art

Patent Document 1 describes a configuration in which “a sub-bus connected to a sub-processing unit is provided in addition to a main bus connected to a main processing unit” as “a technology that allows improving control reliability while reducing a design load of a redundant system in automated driving control”. Patent Document 2 describes a configuration including an ADAS control ECU and an actuator ECU that receives a control instruction signal sent from the ADAS control ECU and controls driving of a vehicle based on the control instruction signal.

### PRIOR ART DOCUMENTS

### Patent Documents

Patent Document 1: Japanese Patent Application Publication No. 2019-189029.
Patent Document 2: Japanese Patent Application Publication No. 2020-108132.

### BRIEF DESCRIPTION OF THE DRAWINGS

FIG. 1 schematically shows a vehicle 20 mounted with a control unit 30 according to one embodiment.

FIG. 2 schematically shows functional configurations of the vehicle 20 and the control unit 30.

FIG. 3 schematically shows system configurations of a first control system 100 and a second control system 200 together with a first sensor 101, a second sensor 201, a controlled device 180, and a controlled device 280.

FIG. 4 schematically shows functional configurations of a first ECU 110, a core ECU 120, and a second ECU 210.

FIG. 5 schematically shows a time sequence of processing executed in the first control system 100 and the second control system 200.

FIG. 6 is a flow chart showing processing procedures executed by the first ECU 110 and the second ECU 210.

FIG. 7 is a flow diagram in which functions of the first ECU 110 and the second ECU 210 are separately described for a normal processing and a fail-safe processing.

FIG. 8 schematically shows a variation of the time sequence of the processing executed in the first control system 100 and the second control system 200.

FIG. 9 schematically shows a variation of the time sequence of the processing executed in the first control system 100 and the second control system 200.

FIG. 10 shows, as a variation of the first control system, a system configuration of a first control system 1100 in which the function of the first ECU 110 is realized by a first ECU 110A and a first ECU 110B.

FIG. 11 schematically shows a time sequence of processing executed in the first control system 1100 and the second control system 200.

FIG. 12 shows an example of a computer 2000 in which a plurality of embodiments of the present invention may be wholly or partially embodied.

### DESCRIPTION OF EXEMPLARY EMBODIMENTS

Hereinafter, the present invention will be described through embodiments of the invention, but the following embodiments do not limit the claimed invention. Moreover, not all combinations of features described in the embodiments are necessary to solutions of the invention.

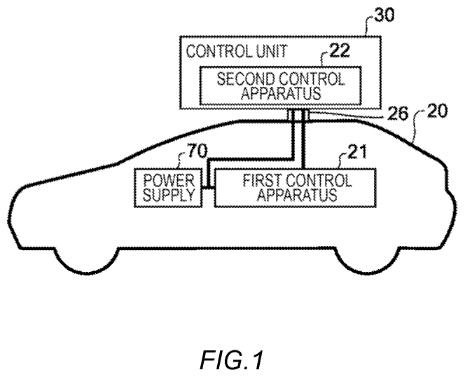

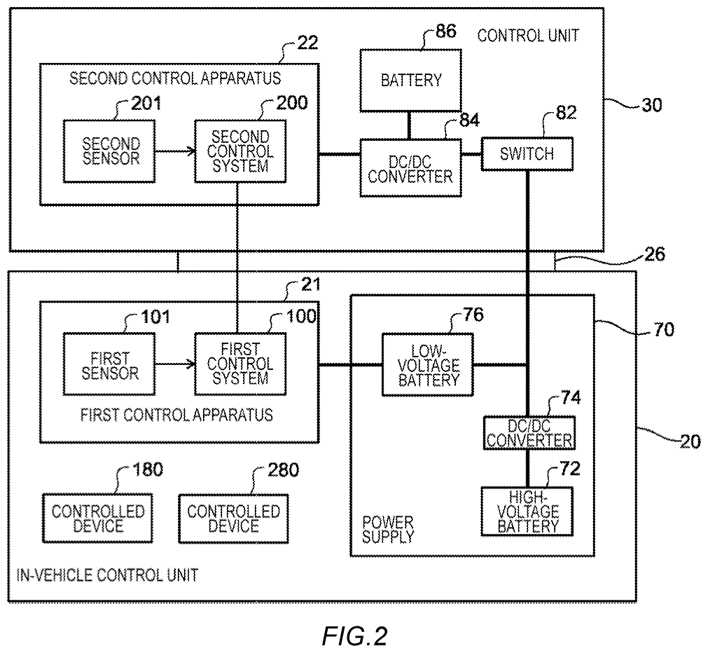

FIG. 1 schematically shows a vehicle 20 mounted with a control unit 30 according to one embodiment. FIG. 2 schematically shows functional configurations of the vehicle 20 and the control unit 30. The control unit 30 and a first control apparatus 21 perform, in cooperation with each other, at least a part of control over driver assistance of the vehicle 20 based on information on a to-be-monitored object.

The vehicle 20 includes the first control apparatus 21 and a power supply 70. The first control apparatus 21 is provided in the vehicle 20. The control unit 30 can be mounted on the vehicle 20. The control unit 30 is mounted outside the vehicle 20. The first control apparatus 21 has, for example, a function of generating control information for advanced driver-assistance systems (ADAS). A second control apparatus 22 has, for example, a function of generating control information for automated driving. It should be noted that this example embodiment shows an example embodiment in which the control unit 30 is mounted outside the vehicle 20 but the control unit 30 may be provided inside the vehicle.

The first control apparatus 21 includes a first sensor 101 and a first control system 100. The first sensor 101 includes, for example, a camera, a radar, a location sensor, and the like. The first control system 100 generates a first calculation result concerning the to-be-monitored object based on information acquired by the first sensor 101. For example, the first control system 100 generates a recognition result of an object such as an outside pedestrian or another vehicle or obstacle acquired by each of the sensors included in the first sensor 101 as well as control information that is based on the recognition result, to generate them as the first calculation result.

When the second control apparatus 22 is not mounted on the vehicle 20, the first control system 100 generates control information for generating control signal concerning steering of the vehicle 20 or the like based on the first calculation result. A controlled device 180 included in the vehicle 20 is controlled based on the control information. On the other hand, when the second control apparatus 22 is mounted on the vehicle 20, the first calculation result calculated by the first control system 100 is delivered to the second control apparatus 22 through a connection port 26.

The second control apparatus 22 includes a second sensor 201 and a second control system 200. The second control apparatus 22 includes the connection port 26 for mounting the second control apparatus 22 outside the vehicle 20. Electrical power is supplied to the second control apparatus 22 from a power supply 70 through an electrical power wiring provided in the connection port 26. The second control system 200 can communicate with the first control system 100 through a communication wiring provided in the connection port 26.

The second sensor 201 includes, for example, a camera, a Lidar, or the like. The second control system 200 calculates information on the to-be-monitored object based on information acquired by the second sensor 201 and the first calculation result acquired from the first control system 100. For example, the second control system 200 generates a second calculation result in addition to the first calculation result, in further consideration with a recognition result such as a location of an object such as an outside pedestrian or another vehicle or obstacle acquired by the second sensor 201. The second calculation result calculated by the second control system 200 is delivered to the first control system 100 through the connection port 26.

When the second control apparatus 22 is mounted on the vehicle 20, the first control system 100 calculates, at least based on the second calculation result, control information for controlling the steering of the vehicle 20 or the like.

Thus, the second control system 200 generates the second calculation result based on the first calculation result generated by the first control system 100 and the information acquired by the second sensor 201. As such, for example, when developing a vehicle with an automated driving function provided by the second control apparatus 22, it is possible to use an ADAS function provided by the first control apparatus 21 including the first sensor 101 and the first control system 100, so that the number of developing processes of a control system of the vehicle can be reduced. Moreover, mounting the second control apparatus 22 on the vehicle with the ADAS function provided by the first control apparatus 21 allows addition of the automated driving function provided by the second control apparatus 22, and using the first sensor or the like can reduce a manufacturing cost.

It should be noted that this embodiment describes the vehicle 20 as a hybrid automobile. The power supply 70 included in the vehicle 20 includes a high-voltage battery 72, a DC/DC converter 74, and a low-voltage battery 76. The high-voltage battery 72 is a lithium-ion battery or the like. The high-voltage battery 72 is a battery to supply electrical power to a traction motor. The DC/DC converter 74 converts high-voltage electrical power of the high-voltage battery 72 into low-voltage electrical power. The low-voltage electrical power converted by the DC/DC converter 74 may charge the low-voltage battery 76. The low-voltage battery 76 is, for example, a battery with an output voltage of 12V. The low-voltage battery 76 is, for example, a lead storage battery. The first control apparatus 21 operates with electrical power supplied from the low-voltage battery 76.

An output of the DC/DC converter 74 is connected to one end of a switch 82 in the control unit 30 through an electrical power line in the connection port 26. The other end of the switch 82 is connected to a DC/DC converter 84. The second control apparatus 22 operates with electrical power converted by the DC/DC converter 84. The DC/DC converter 84 is connected to a battery 86, stores electrical power in the battery 86, and performs conversion of an output electrical power of the battery 86 for a supply to the second control apparatus 22. A capacity of the battery 86 may be designed according to electrical power consumption of the second control apparatus 22. For example, when the second control apparatus 22 is responsible for control over automated driving, the capacity of the battery 86 may be designed according to an automated driving level provided by the second control apparatus 22.

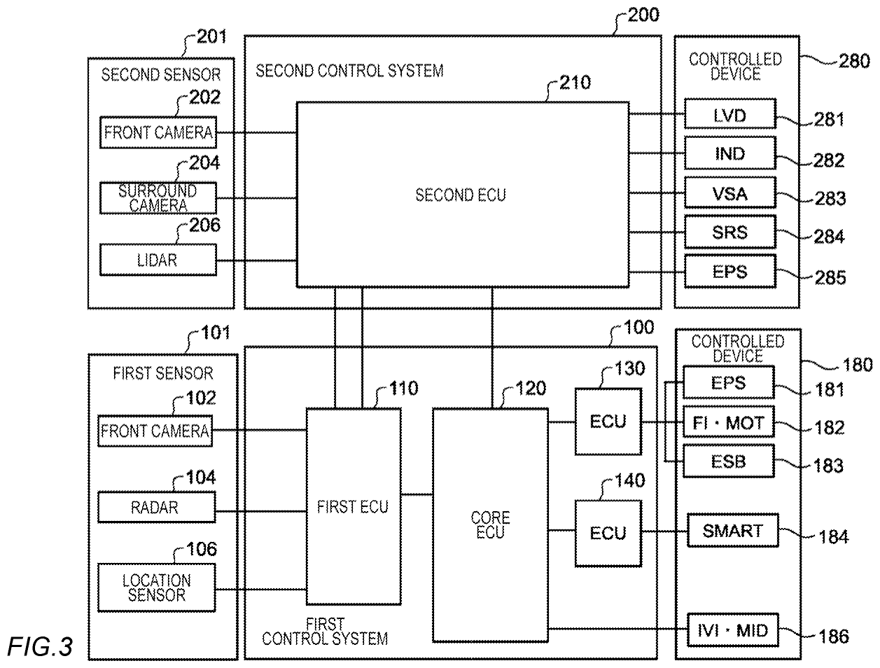

FIG. 3 schematically shows system configurations of a first control system 100 and a second control system 200 together with a first sensor 101, a second sensor 201, a controlled device 180, and a controlled device 280. It should be noted that FIG. 3 shows some of components included in the vehicle 20, and the vehicle 20 may include components other than the components shown in FIG. 3. The first control system 100 and the second control system 200 function as a control system of the vehicle 20. The first control system 100 and the second control system 200 perform at least a part of control over driver assistance of the vehicle 20.

A first ECU 110, a core ECU 120, an ECU 130, an ECU 140, a second ECU 210, a controlled device 180, and a controlled device 280 are directly or indirectly connected communicatively through a communication network. An in-vehicle communication line may be configured to include, for example, a CAN (registered trademark) (Controller Area Network), a network compliant with an IEEE802.3 series, or the like. Similarly, the first ECU 110 acquires information from the first sensor 101 through the communication network, and the second ECU 210 acquires information from the second sensor 201 through the communication network.

The first sensor 101 includes a front camera 102, a radar 104, and a location sensor 106. The front camera 102 mainly captures an image of an area in front of the vehicle 20, and generates, from the image obtained through the image-capturing, recognition information of an object existing in front of the vehicle 20. The radar 104 generates information on distance to an object existing around the vehicle 20. For example, the location sensor 106 includes a GNSS receiver or the like that receives a signal transmitted from a GNSS satellite, and generates location information of the vehicle 20 based on the signal received from the GNSS satellite.

The second sensor 201 includes a front camera 202, surround camera 204, and a Lidar 206. The front camera 202 mainly captures the image of the area in front of the vehicle 20, and generates, from the image obtained by the image-capturing, the recognition information of the object existing in front of the vehicle 20. The front camera 202 may generate recognition information with higher precision than the front camera 102. An imaging rate of the front camera 202 may be higher than an imaging rate of the front camera 102. An imaging resolution of the front camera 202 may be higher than an imaging resolution of the front camera 102. A brightness resolution of the front camera 202 may be higher than a brightness resolution of the front camera 102. A color resolution of the front camera 202 may be higher than a color resolution of the front camera 102. The surround camera 204 captures an image of an area around the vehicle 20, to generate, from the image obtained through the image-capturing, recognition information of the object existing around the vehicle 20. The Lidar 206 is a laser Lidar, an infrared Lidar, or the like. The Lidar 206 generates the information on the distance to the object existing around the vehicle 20.

The first control system 100 includes the first ECU 110, the core ECU 120, the ECU 130, and the ECU 140. The controlled device 180 is mainly a device to be controlled by the first control system 100. The controlled device 180 includes an EPS 181, an FT/MOT 182, an ESB 183, and a SMART 184, an IVI/MID 186, or the like.

The first ECU 110 controls, for example, ADAS. In addition to the ADAS, the first ECU 110 controls recording of various event data, management of the low-voltage battery 76, and exchange of information generated by the first sensor 101. A function of recording event data is, for example, a function of recording information acquired by the first sensor 101 or the like when there is an event generated such as switching of an automated driving level.

The first ECU 110 generates a first calculation result based on the information acquired from the first sensor 101, and outputs control information to the core ECU 120. The core ECU 120 generates, based on the information acquired from the first ECU 110 or the second ECU 210, control information for directly or indirectly controlling the controlled device 180 and the IVI/MID 186. For example, the core ECU 120 controls the IVI/MID 186. The ECU 130 controls the EPS 181, the FT/MOT 182, and the ESB 183 based on the control information received from the core ECU 120. The ECU 140 controls the SMART 184 or the like based on the control information supplied from the core ECU 120. The core ECU 120 generates, for example, control information for controlling steering of the vehicle 20.

The EPS 181 is an electric power steering apparatus. Specifically, the EPS 181 is an electric power steering apparatus of a regular system. The FT/MOT 182 includes a fuel injection apparatus and a traction motor control apparatus. It should be noted that the fuel injection apparatus does not need to be included when the vehicle 20 is an electric automobile and the traction motor control apparatus does not need to be included when the vehicle 20 is an automobile with no traction motor.

The ESB 183 is an electric servo brake. The SMART 184 is a device to provide a smart entry function. The IVI/MID 186 includes, for example, an in-vehicle infotainment information device (IVI) and a multi-information display (MID). The IVI/MID 186 displays notice information to a driver of the vehicle 20.

The second control system 200 includes the second ECU 210. The second ECU 210 controls, for example, automated driving. Moreover, the second ECU 210 communicates with the first ECU 110 or the core ECU 120, and controls the controlled device 180 in cooperation with the first control system 100. Moreover, the second ECU 210 controls the controlled device 280. The second ECU 210 also performs recording of various event data, driving recording, management of a power supply system included in the control unit 30, or the like.

The controlled device 280 is a device directly or indirectly controlled by the second control system 200. The controlled device 280 includes an LVD 281, an IND 282, a VSA 283, an SRS 284, and an EPS 285. The LVD 281 is configured to include the DC/DC converter 84. The IND 282 is a device to give a notice to an occupant of the vehicle 20. The VSA 283 is a device to provide a skidproof function of the vehicle 20. For example, the VSA 283 is a device to integrally control an antilock brake system (ABS) and a traction control system (TCS). The SRS 284 includes a supplemental restraint system such as an SRS air bag as well as a G sensor or a yaw rate sensor to control deployment of the SRS air bag. The EPS 285 is an electric power steering apparatus. Specifically, the EPS 285 is an electric power steering apparatus of an emergency system. The controlled device 280 may be a device for controlling a motion of the vehicle 20 and giving a notice to the occupant in case of emergency.

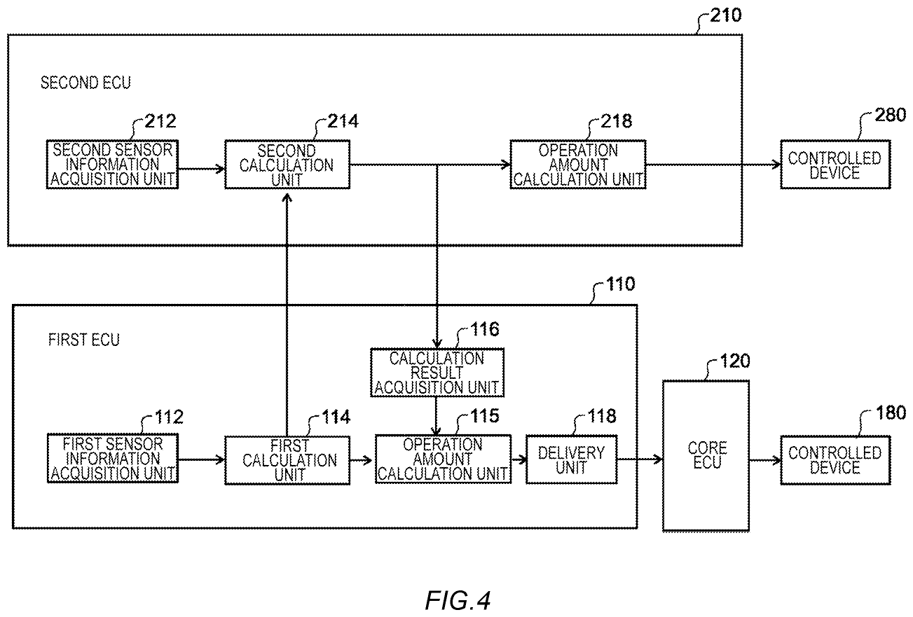

FIG. 4 schematically shows functional configurations of a first ECU 110, a core ECU 120, and a second ECU 210. A function of the first control system 100 is realized by the first ECU 110, and a function of the second control system 200 is realized by the second ECU 210. The first ECU 110 calculates a calculation result concerning a to-be-monitored object from information acquired from the first sensor 101, and the second ECU 210 calculates the calculation result concerning the to-be-monitored object from information acquired from at least the second sensor 201. The second ECU 210 acquires the calculation result by the first ECU 110, and calculates the calculation result concerning the to-be-monitored object from the calculation result by the first ECU 110 and the information acquired from the second sensor 201.

The first ECU 110 includes a first sensor information acquisition unit 112, a first calculation unit 114, a calculation result acquisition unit 116, an operation amount calculation unit 115, and a delivery unit 118. The second ECU 210 includes a second sensor information acquisition unit 212, a second calculation unit 214, and an operation amount calculation unit 218. The operation amount calculation unit 115 and the operation amount calculation unit 218 are functional blocks responsible for at least a part of vehicle motion control (VMC).

The operation amount calculation unit 115 included in the first ECU 110 and the operation amount calculation unit 218 included in the second ECU 210 calculate, for example, control information for controlling a controlled device on steering of the vehicle 20. The operation amount calculation unit 115 and the operation amount calculation unit 218 calculate an operation amount of, for example, a steering wheel, an accelerator, a brake, a shift, or the like. The controlled device controlled based on the operation amount calculated by the operation amount calculation unit 115 is, for example, the ESP 181, the FT/MOT 182, the ESB 183, or the like included in the controlled device 180. The controlled device controlled based on the operation amount calculated by the operation amount calculation unit 218 is a VSA 283, an EPS 285, or the like included in the controlled device 280.

The first sensor information acquisition unit 112 acquires information from the first sensor 101. The first calculation unit 114 calculates information on the to-be-monitored object from the information acquired by the first sensor information acquisition unit 112. The connection port 26 delivers a calculation result of the first calculation unit 114 to the second control system 200. The connection port 26 is one example of a first delivery unit capable of delivering the calculation result of the first calculation unit 114 to the second control system 200. The first delivery unit may be implemented in the first ECU 110 or the like as a functional block to deliver data.

The second sensor information acquisition unit 212 acquires the information acquired from the second sensor 201 different from the first sensor 101. The second calculation unit 214 calculates the information on the to-be-monitored object based on the calculation result of the first calculation unit 114 delivered by the connection port 26 and the information acquired by the second sensor information acquisition unit 212.

Thus, the control system including the first ECU 110 and the second ECU 210 provides the delivery unit for sending the calculation result concerning the to-be-monitored object of the first ECU 110 to the second ECU 210, and calculates, in the second ECU 210, the information on the to-be-monitored object using the calculation result of the first ECU 110. This allows, for example, usage of the first ECU 110 for both a vehicle only with an ADAS function and a vehicle with an ADAS function and an automated driving function. As such, volume efficiency can reduce a manufacturing cost of the ECU that provides the ADAS function. Moreover, since the second ECU 210 only has to be mainly implemented with a function concerning automated driving control, functions implemented in the second ECU 210 can be reduced. This may allow suppression of an increase in a manufacturing cost or a design cost of the vehicle with the automated driving function. Moreover, this may allow suppression of an increase in the number of developing processes.

The calculation result acquisition unit 116 acquires a calculation result of the second calculation unit 214. For example, the calculation result of the second calculation unit 214 is delivered to the first ECU 110 by the connection port 26. It should be noted that the connection port 26 is one example of a delivery unit capable of delivering the calculation result of the second calculation unit 214 to the first control system 100. The delivery unit may be implemented in the second ECU 210 or the like as a functional block to deliver data. The operation amount calculation unit 115 calculates the operation amount based on the calculation result of the first calculation unit 114 or the calculation result of the second calculation unit 214 acquired by the calculation result acquisition unit 116. The delivery unit 118 delivers the operation amount calculated by the operation amount calculation unit 115 to the core ECU 120. The core ECU 120 directly or indirectly controls the controlled device 180 based on the operation amount acquired from the first ECU 110. Thus, adopting a configuration in which the calculation result of the second calculation unit 214 is returned to the first ECU 110 and the calculation result of the second calculation unit 214 is input to the operation amount calculation unit 115 via the calculation result acquisition unit 116, may be able to suppress an increase in an overall manufacturing cost of the vehicle control system or the number of developing processes.

When determining that the first control system 100 has failed, the second calculation unit 214 performs calculation concerning the to-be-monitored object only based on the information acquired by the second sensor information acquisition unit 212, and delivers the calculation result of the second calculation unit 214 to the operation amount calculation unit 218 that calculates the operation amount of the vehicle 20. This allows an evacuation action of the vehicle 20 through the operation amount calculation unit 218 even when the first ECU 110 has failed. Moreover, this allows the evacuation action without implementation of a dedicated redundant system. As such, the increase in the manufacturing cost of the vehicle can be suppressed. It should be noted that, when an abnormality is generated in the first ECU 110, it may be determined that the first control system 100 has failed. Whether the first control system 100 has failed may be determined based on a communication state of the first ECU 110, an event generated in the vehicle control system, or the like. It should be noted that whether the first control system 100 has failed may also be determined based on whether the second calculation unit 214 has not been able to acquire the calculation result of the first calculation unit 114 from the first ECU 110.

When determining that the second control system 200 has failed, the first calculation unit 114 performs calculation concerning the to-be-monitored object only based on the information acquired from the first sensor 101, and delivers, to the core ECU 120, the operation amount calculated by the operation amount calculation unit 115 based on the calculation result of the first calculation unit 114. This allows the evacuation action of the vehicle 20 even when the second ECU 210 has failed. It should be noted that, when an abnormality is generated in the second ECU 210, it may be determined that the second control system 200 has failed. Whether the second control system 200 has failed may be determined based on a communication state of the second ECU 210, an event generated in the vehicle control system, or the like. It should be noted that whether the second control system 200 has failed may also be determined based on whether the first calculation unit 114 has not been able to acquire the calculation result of the second calculation unit 214 from the second ECU 210.

A power supply to supply electrical power to the second control system 200 may be mounted on one housing. For example, as shown in connection with FIG. 1, FIG. 2, and the like, the battery 86 may be mounted in a housing of the control unit 30. Moreover, the second sensor 201 may be mounted in the housing of the control unit 30. As a result, for example, mounting the control unit 30 on a vehicle with the ADAS function provided by the first control system 100 and with no automated driving function allows addition of the automated driving function provided by the second control system 200. It should be noted that the housing of the control unit 30 may be mounted outside the vehicle. For example, as shown in FIG. 1 or the like, the housing of the control unit 30 may be mounted on a roof of the vehicle 20. This allows addition at low cost of the automated driving function provided by the second control system 200.

The first sensor information acquisition unit 112 and the second sensor information acquisition unit 212 may respectively acquire information from the first sensor and the second sensor according to a common synchronous signal supplied at a predetermined cycle. When the first control system 100 has not acquired the calculation result of the second calculation unit 214 within one cycle of the synchronous signal, the first calculation unit 114 may deliver the calculation result of the first calculation unit 114 to the operation amount calculation unit 115. Moreover, when the second control system 200 has not acquired the calculation result of the first calculation unit 114 within one cycle of the synchronous signal, the second calculation unit 214 may perform calculation concerning the to-be-monitored object only based on the information acquired from the second sensor 201, and deliver the calculation result of the second calculation unit 214 to the operation amount calculation unit 218. This allows steering control of the vehicle 20 or the like even when the second ECU 210 has not been able to acquire the calculation result of the first calculation unit 114 or even when the first ECU 110 has not been able to acquire the calculation result of the second calculation unit 214.

It should be noted that the first sensor information acquisition unit 112 may acquire the information from the first sensor according to the synchronous signal supplied at the predetermined cycle and that the second calculation unit 214 may calculate the information on the to-be-monitored object based on the calculation result of the first calculation unit 114 delivered from the first delivery unit and the information acquired by the second sensor information acquisition unit 212, according to an event signal generated when the first delivery unit delivers the calculation result of the first calculation unit 114, and deliver the calculation result to the first control system 100. In this case, when the first control system 100 has not acquired the calculation result of the second calculation unit 214 within one cycle of the synchronous signal, the first calculation unit 114 may deliver the calculation result of the first calculation unit 114 to the operation amount calculation unit 115. This allows steering control of the vehicle 20 or the like even when the first ECU 110 has not been able to acquire the calculation result of the second calculation unit 214.

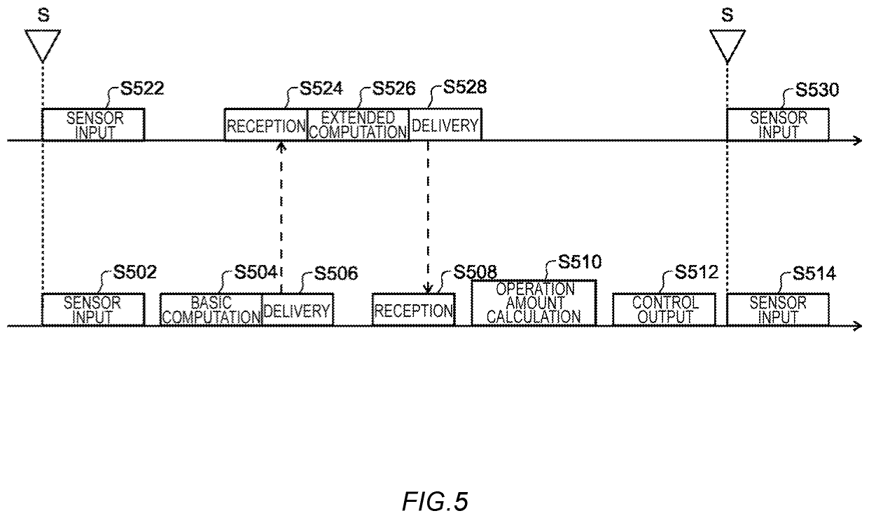

FIG. 5 schematically shows a time sequence of processing executed in the first control system 100 and the second control system 200.

In S502, the first sensor information acquisition unit 112 acquires information generated by the first sensor 101. Moreover, in S522, the second sensor information acquisition unit 212 acquires information generated by the second sensor 201. For example, a common synchronous signal S is repeatedly supplied to the first sensor information acquisition unit 112 and the second sensor information acquisition unit 212 at the same cycle and at the same timing, and the first sensor information acquisition unit 112 and the second sensor information acquisition unit 212 respectively acquire the information generated by the first sensor 101 and the information generated by the second sensor 201 at the same timing or substantially at the same timing.

In S504, the first calculation unit 114 generates a first calculation result based on the information acquired by the first sensor information acquisition unit 112 (basic computation). The first calculation unit 114 may integrate the information acquired by the first sensor information acquisition unit 112, to generate the first calculation result including control information of the vehicle 20. The first calculation unit 114 may generate, by integrating the information acquired by the first sensor information acquisition unit 112, the first calculation result that includes information indicating a location of a to-be-monitored object located in front of the vehicle 20, a distance to the to-be-monitored object, a type of the to-be-monitored object, and the like.

In S506, the first calculation result calculated by the first calculation unit 114 is delivered by the connection port 26 to the second calculation unit 214. As a result, in S524, the second calculation unit 214 acquires the first calculation result through the connection port 26. In S526, the second calculation unit 214 generates a second calculation result based on sensor information acquired in S512 and the first calculation result (extended computation). The second calculation unit 214 may integrate the sensor information acquired in S522 and the first calculation result, to generate the second calculation result including the control information of the vehicle 20. As one example, when the first control system 100 is responsible for processing concerning ADAS, and the second control system 200 is responsible for processing concerning automated driving, the second calculation unit 214 may, without performing the processing concerning the ADAS, perform processing of calculating control information on the automated driving based on the sensor information acquired in S522 and the first calculation result, and output it as the second calculation result. The second calculation result may include control information on the ADAS based on the first calculation result and the control information on the automated driving.

In S528, the second calculation unit 214 delivers the second calculation result to the first ECU 110. In the first ECU 110, when the second calculation result is acquired by the calculation result acquisition unit 116 (S508), the operation amount calculation unit 115 calculates an operation amount based on the second calculation result (S510), and the delivery unit 118 outputs, to the core ECU 120, control information indicating the calculated operation amount (S512).

Subsequently, when the next synchronous signal S is supplied, in S514, the first sensor information acquisition unit 112 newly acquires the information generated by the first sensor 101, the second sensor information acquisition unit 212 newly acquires the information generated by the second sensor 201. Subsequently, the first ECU 110 and the second ECU 210 repeat the same sequence as the sequence starting from S502 and S522. Through the above processing, the control information based on the second calculation result is periodically output to the core ECU 120.

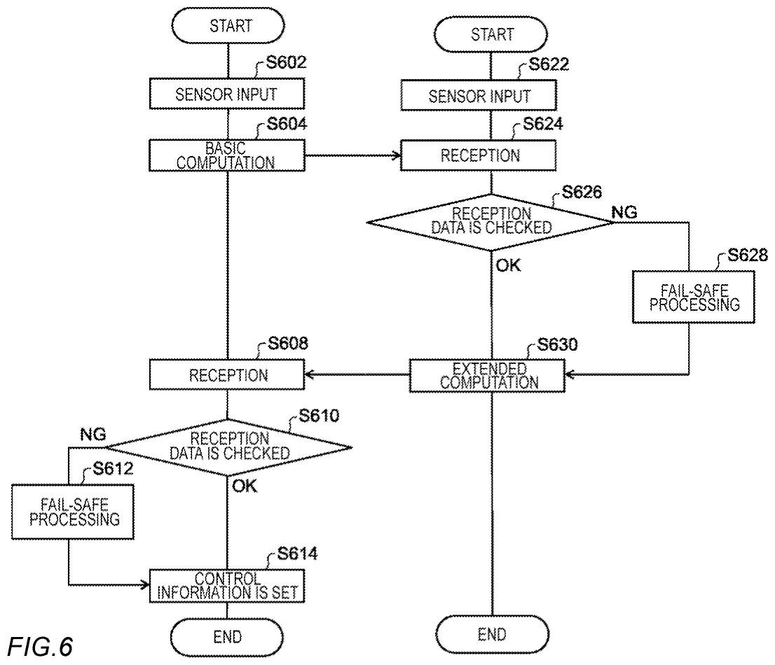

FIG. 6 is a flow chart showing processing procedures executed by the first ECU 110 and the second ECU 210. The processing shown in FIG. 6 is processing executed within one cycle of a synchronous signal.

In S602, the first sensor information acquisition unit 112 acquires information generated by the first sensor 101. Moreover, in S622, the second sensor information acquisition unit 212 acquires information generated by the second sensor 201. S602 and S622 are executed in response to reception of the synchronous signal.

In S604, the first calculation unit 114 performs the above-mentioned basic computation, generates a first calculation result based on the information acquired by the first sensor information acquisition unit 112, and delivers the first calculation result to the second ECU 210 via the connection port 26. In S624, the second ECU 210 receives the first computation result.

In S626, the second calculation unit 214 checks the received first computation result. For example, the second calculation unit 214 makes a positive determination (OK) when the first computation result is received within a predetermined time after the most recent synchronous signal is received and when the received first computation result is normal data. On the other hand, the second calculation unit 214 makes a negative determination (NG) when the first computation result is not received within a predetermined time after the most recent synchronous signal is received or when the received first computation result is abnormal data.

If the second calculation unit 214 makes the positive determination in S626, it performs extended computation (S630). Specifically, the second calculation unit 214 generates the second calculation result based on the sensor information acquired in S602 and the first calculation result received in S624, and delivers the second calculation result to the second ECU 210 via the connection port 26.

On the other hand, if the second calculation unit 214 makes the negative determination in S626, it performs a fail-safe processing (S628). For example, the second calculation unit 214 generates the second calculation result only based on the information acquired from the second sensor 201 in S622. The second calculation result generated in S628 may be delivered to the first ECU 110 via the connection port 26 as a result of the extended computation in S630.

In S608, when the second calculation result is acquired by the calculation result acquisition unit 116, the operation amount calculation unit 115 checks the received second computation result. For example, the operation amount calculation unit 115 makes a positive determination (OK) when the second computation result is received within a predetermined time after the most recent synchronous signal is received and when the received second computation result is normal data. On the other hand, the operation amount calculation unit 115 makes a negative determination (NG) when the second computation result is not received within a predetermined time after the most recent synchronous signal is received or when the received second computation result is abnormal data.

If the operation amount calculation unit 115 makes the positive determination in S610, it calculates an operation amount based on the second calculation result, and sets the calculated operation amount as control information to be output to the core ECU 120 (S614). On the other hand, if the negative determination is made in S610, the a fail-safe processing is performed (S612). For example, as the fail-safe processing, the operation amount calculation unit 115 calculates an operation amount based on the first calculation result generated only based on the information acquired by the first calculation unit 114 from the first sensor 101, and in S614, the calculated operation amount is set as control information to be output to the core ECU 120.

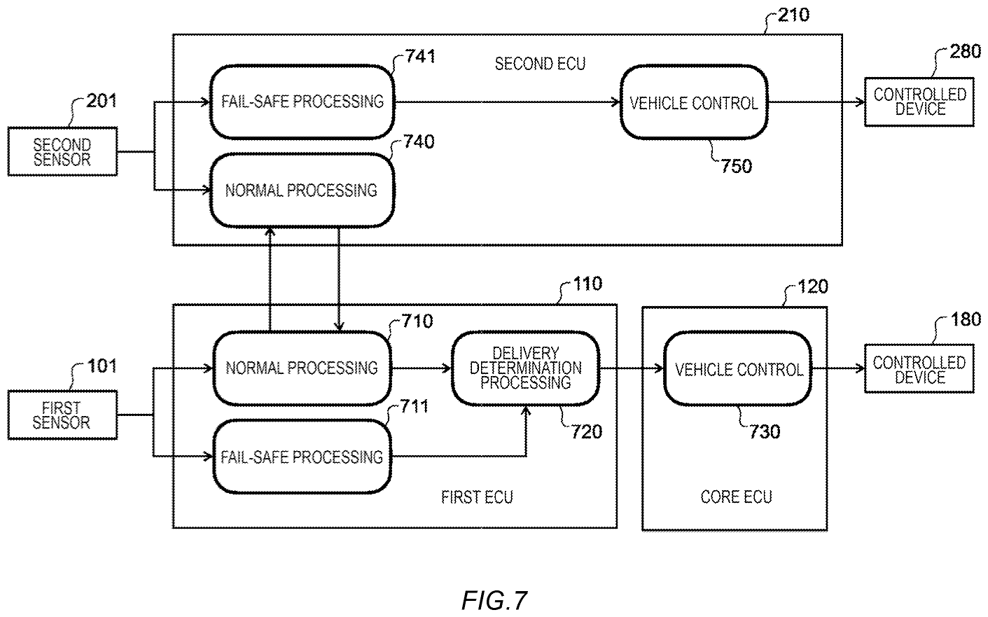

FIG. 7 is a flow diagram in which functions of the first ECU 110 and the second ECU 210 are separately described for a normal processing and a fail-safe processing. A normal processing 710 in the first ECU 110 and a normal processing 740 in the second ECU 210 are executed when neither the first ECU 110 nor the second ECU 210 has failed. The normal processing 710 and the normal processing 740 are realized by the first calculation unit 114, the second calculation unit 214, and the calculation result acquisition unit 116. As mentioned above, in the normal processing 710, a first calculation result calculated by the first calculation unit 114 is delivered to the second calculation unit 214, a second calculation result is calculated in the second calculation unit 214 based on the information acquired from the second sensor 201 and the first calculation result, and the second calculation result is acquired by the calculation result acquisition unit 116.

A fail-safe processing 711 in the first ECU 110 is processing in which the first calculation result is calculated by the first calculation unit 114 only based on the information acquired from the first sensor 101. The fail-safe processing 711 may be executed when the second ECU 210 has failed. The fail-safe processing 711 may be executed when the second calculation result has not been able to be received from the second calculation unit 214. The fail-safe processing 711 may be executed when the second calculation result received from the second calculation unit 214 is abnormal.

A delivery determination processing 720 is processing of outputting, as control information to be output to the core ECU 120, an operation amount calculated based on one of the second calculation result obtained through the normal processing 710 and the first calculation result obtained through the fail-safe processing 711. In a case where the second ECU 210 has failed or the like, the operation amount based on the first calculation result obtained through the fail-safe processing 711 is delivered to the core ECU 120 through the delivery determination processing 720. When the second ECU 210 has not failed, the operation amount based on the second calculation result obtained through the normal processing 710 is delivered to the core ECU 120. Vehicle control 730 includes processing executed based on the operation amount calculated by the operation amount calculation unit 115, and is processing of controlling at least a part of the controlled device 180 based on the information acquired from the first ECU 110.

A fail-safe processing 741 in the second ECU 210 is processing in which the second calculation result is calculated by the second calculation unit 214 only based on the information acquired from the second sensor 201. The fail-safe processing 741 may be executed when the first ECU 110 has failed. The fail-safe processing 741 may be executed when the second calculation unit 214 has not been able to receive the first calculation result from the first calculation unit 114. The fail-safe processing 741 may be executed when the first calculation result received from the first calculation unit 114 is abnormal. Vehicle control 750 includes processing executed by the operation amount calculation unit 218, and is processing of controlling at least a part of the controlled device 280 based on the second calculation result through the fail-safe processing 741.

As described above, according to the first control system 100 and the second control system 200, the second control system 200 acquires a first calculation result concerning an ADAS function generated by the first control system 100, to generate, based on the first calculation result and the information acquired from the second sensor 201, the second calculation result including information on an automated driving function, to deliver it to the first ECU 110. As such, an increase in a design, development, or manufacturing cost of a vehicle with the automated driving function can be suppressed. Further, in the vehicle 20 mounted with the second control system 200, even in case of emergency such as a failure of the first control system 100, the second control system 200 allows realization of motion control of the vehicle 20 or of notification to an occupant.

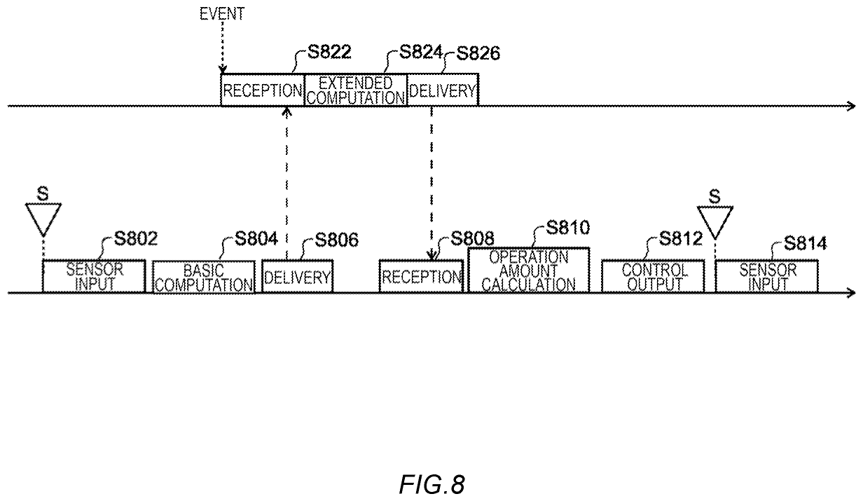

FIG. 8 schematically shows a variation of the time sequence of the processing executed in the first control system 100 and the second control system 200. Unlike the time sequence shown in FIG. 6, the time sequence shown in FIG. 8 does not have a configuration in which the first ECU 110 and the second ECU 210 synchronously operate with a common synchronous signal, and the second ECU 210 performs extended computation based on an event signal generated when a first calculation result is delivered by the first ECU 110.

In S802, the first sensor information acquisition unit 112 acquires information generated by the first sensor 101. For example, a synchronous signal S is repeatedly supplied to the first ECU 110, and the first sensor information acquisition unit 112 acquires the information generated by the first sensor 101 in response to the synchronous signal S.

In S804, the first calculation unit 114 generates the first calculation result based on the information acquired by the first sensor information acquisition unit 112 (basic computation). In S806, the first calculation result calculated by the first calculation unit 114 is delivered by the connection port 26 to the second calculation unit 214. At this time, the second ECU 210 is supplied with an event signal indicating that the first calculation result is to be sent. For example, the event signal may be generated when the first calculation result is delivered by the first ECU 110.

In 822, the second calculation unit 214 acquires the first calculation result through the connection port 26. In S824, the second calculation unit 214 generates a second calculation result based on sensor information acquired from the second sensor 201 and the first calculation result (extended computation).

In S826, the second calculation unit 214 delivers the second calculation result to the first ECU 110 through the connection port 26. In the first ECU 110, when the second calculation result is acquired by the calculation result acquisition unit 116 (S808), the operation amount calculation unit 115 calculates an operation amount based on the second calculation result (S810), and the delivery unit 118 outputs, to the core ECU 120, control information indicating the calculated operation amount (S812).

Subsequently, when the next synchronous signal S is supplied, in S814, the first sensor information acquisition unit 112 newly acquires the information generated by the first sensor 101, the second sensor information acquisition unit 212 newly acquires the information generated by the second sensor 201. Subsequently, the first ECU 110 and the second ECU 210 repeat the same sequence as the sequence starting from S802 and S822. As a result, the control information based on the second calculation result is periodically output to the core ECU 120.

It should be noted that the second computation result in S826 may be sent at a fixed cycle. For example, a synchronous signal for transmission control is repeatedly supplied to the second ECU 210 at a fixed cycle, and after the second computation result is calculated by the second calculation unit 214, the second computation result may be sent when the synchronous signal for transmission control is first supplied to the second ECU 210.

It should be noted that, as described in connection with FIG. 6 or the like, in S808 the first calculation unit 114 may set, as control information to be output to the core ECU 120, an operation amount that is based on the first calculation result obtained in S804, when the second calculation result is not received within a predetermined time after the most recent synchronous signal S is received or when the received second calculation result is abnormal data.

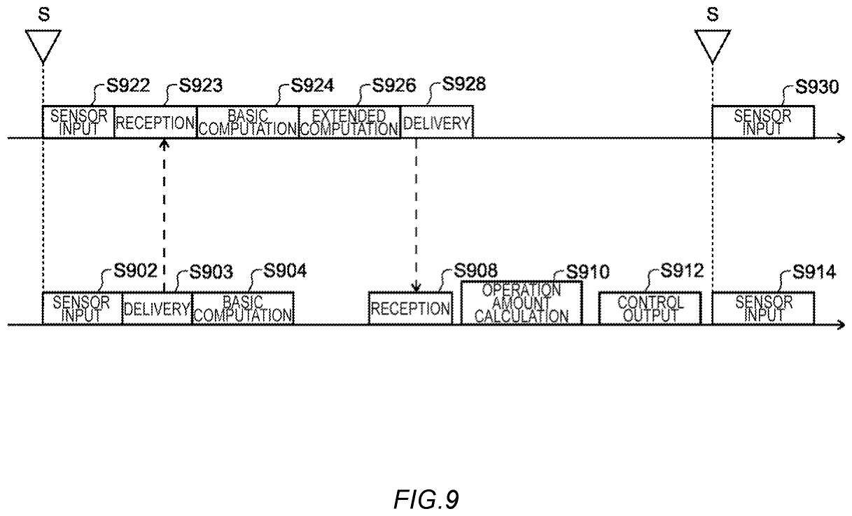

FIG. 9 schematically shows a variation of the time sequence of the processing executed in the first control system 100 and the second control system 200. The time sequence shown in FIG. 9 is a time sequence for when the second control system 200 performs not only extended computation but also basic computation. It should be noted that, like the time sequence in FIG. 5, the time sequence in FIG. 9 is a time sequence for when a common synchronous signal S is repeatedly supplied to the first sensor information acquisition unit 112 and the second sensor information acquisition unit 212 at the same cycle and at the same timing.

In S902, the first sensor information acquisition unit 112 acquires information generated by the first sensor 101. Moreover, in S922, the second sensor information acquisition unit 212 acquires information generated by the second sensor 201.

In S903, the information acquired by the first sensor information acquisition unit 112 in S902 is delivered to the second control system 200. Moreover, in S904, the first calculation unit 114 generates a first calculation result based on the information acquired by the first sensor information acquisition unit 112 (basic computation). It should be noted that, in S903 and S904, the first calculation unit 114 may deliver the information acquired by the first sensor information acquisition unit 112 to the first control system 100 and perform the basic computation.

The information acquired by the first sensor information acquisition unit 112 is delivered to the second calculation unit 214 through the connection port 26. When acquiring the information through the connection port 26 in S923, the second calculation unit 214 performs the basic computation based on the information acquired through the connection port 26 (S924). The basic computation performed in S924 may be the same computation as the basic computation performed by the first calculation unit 114 in S904. Subsequently, in S926, a second calculation result is generated based on the first calculation result obtained through the basic computation of S924 and the information acquired in S922 (extended computation).

In S928, the second calculation unit 214 delivers the second calculation result to the first ECU 110. In the first ECU 110, when the calculation result acquisition unit 116 acquires the second calculation result (S908), an operation amount is calculated based on the second calculation result (S910), and the delivery unit 118 outputs, to the core ECU 120, control information indicating the calculated operation amount (S912).

Subsequently, when the next synchronous signal S is supplied, the first sensor information acquisition unit 112 newly acquires, in S914, the information generated by the first sensor 101, and the second sensor information acquisition unit 212 newly acquires the information generated by the second sensor 201. Subsequently, the first ECU 110 and the second ECU 210 repeat the same sequence as the sequence starting from S902 and S922. Through the above processing, the control information reflecting the second calculation result is periodically output to the core ECU 120.

It should be noted that, as described in connection with FIG. 6 or the like, in S908 the first calculation unit 114 may set, as control information to be output to the core ECU 120, an operation amount that is based on the first calculation result obtained in S904, when the second calculation result is not received within a predetermined time after the most recent synchronous signal S is received or when the received second calculation result is abnormal data. Moreover, as described in connection with FIG. 8 or the like, there is no configuration provided in which the first ECU 110 and the second ECU 210 synchronously operate with a common synchronous signal, and the second ECU 210 may perform the extended computation based on an event signal generated when the first ECU 110 sends information to the second ECU 210.

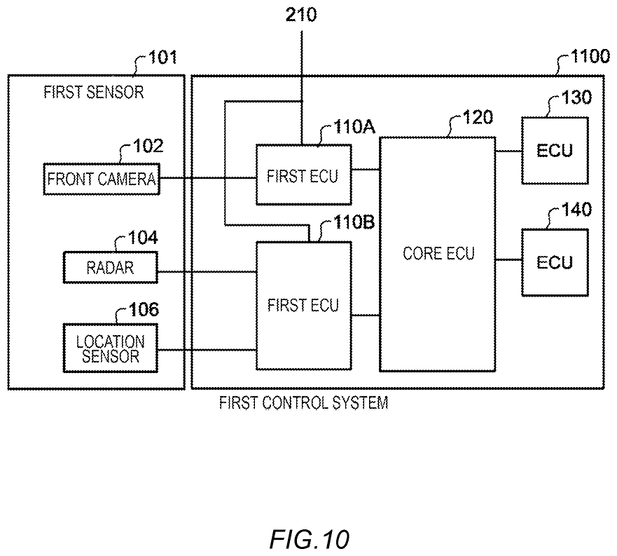

FIG. 10 shows, as a variation of the first control system, a system configuration of a first control system 1100 in which the function of the first ECU 110 is realized by a first ECU 110A and a first ECU 110B. The first ECU 110A performs processing of calculating a first calculation result A based on information acquired from the front camera 102. The first ECU 110B performs processing of calculating a first calculation result B based on information acquired from the radar 104 and the location sensor 106. The first ECU 110A and the first ECU 110B can communicate with each other through a communication network.

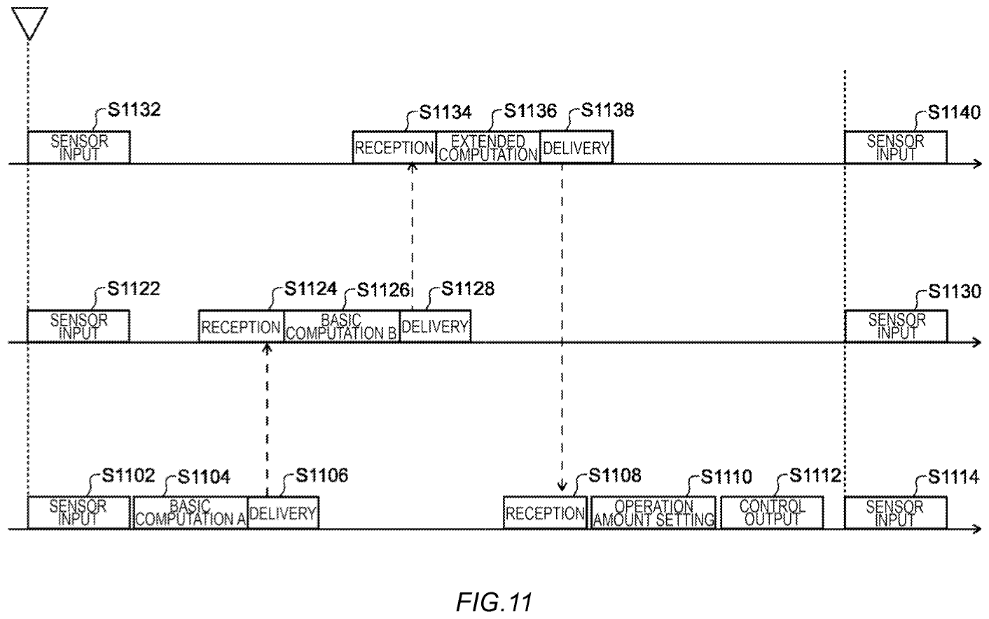

FIG. 11 schematically shows a time sequence of processing executed in the first control system 1100 and the second control system 200.

In S1102, the first ECU 110A acquires information generated by the front camera 102. Moreover, in S1122, the first ECU 110B acquires information generated by the radar 104 and the location sensor 106. Moreover, in S1122, the second ECU 210 acquires information generated by the second sensor 201. For example, a common synchronous signal S is repeatedly supplied to the first ECU 110A, the first ECU 110B, and the second ECU 210 at the same cycle and at the same timing, and the first ECU 110A, the first ECU 110B, and the second ECU 210 acquire, at the same timing or substantially at the same timing, the information generated by each of the sensors.

In S1104, the first ECU 110A generates a first calculation result A based on the information acquired in S1102 (basic computation A).

In S1106, the first calculation result A calculated by the first ECU 110A is delivered to the first ECU 110B. As a result, in S1124, the first ECU 110B acquires the first calculation result A delivered from the first ECU 110A. In S1126, the first ECU 110B generates a first calculation result B based on the information acquired in S1122 and the first calculation result A (basic computation B). The first ECU 110B may integrate the information acquired in S1122 and the first calculation result A, to generate the first calculation result B including control information of the vehicle 20. As one example, the first ECU 110A may perform operation concerning ADAS that is based on the information acquired from the front camera 102, and the first ECU 110A may perform more detailed operation concerning the ADAS in further consideration with the information acquired from the radar 104 and the location sensor 106.

In S1128, the first ECU 110B delivers the first calculation result B to the second ECU 210. In S1134, the second ECU 210 acquires the first calculation result B. In S1136, the second ECU 210 generates a second calculation result based on the information acquired in S1132 and the first calculation result B (extended computation). The second ECU 210 may integrate the information acquire in the S1132 and the first calculation result B, to generate the second calculation result including the control information of the vehicle 20. As one example, when the first control system 1100 is responsible for processing concerning ADAS, and the second control system 200 is responsible for processing concerning automated driving, the second calculation unit 214 may, without performing the processing concerning the ADAS, perform processing of calculating control information for the automated driving based on the sensor information acquired in S522 and the first calculation result, and output it as the second calculation result. The second calculation result may include information on the ADAS based on the first calculation result B.

In 1138, the second ECU 210 delivers the second calculation result to the first ECU 110A. When the first ECU 110A acquires the second calculation result (S1108), the first ECU 110A sets, as control information to be output by the first ECU 110A to the core ECU 120, an operation amount that is based on the second calculation result (S1110), and outputs the second calculation result to the core ECU 120 (S1112).

Subsequently, when the next synchronous signal S is supplied, in S1114, 51130, and S1140, the first ECU 110A newly acquires the information generated by the front camera 102, the first ECU 110B newly acquires the information generated by the radar 104 and the location sensor 106, and the second ECU 210 newly acquires the information generated by the second sensor 201. Subsequently, the first ECU 110A, the first ECU 110B, and the second ECU 210 repeat the same sequence as the sequence starting from S1102, S1122, and S1132. Through the above processing, the control information based on the second calculation result is periodically output to the core ECU 120.

As described in connection with FIG. 10 and FIG. 11, a form can be adopted in which the three ECUs calculate information on control of the vehicle 20 by using calculation result of a lower-level ECU and the information acquired from the sensor. It should be noted that a form may also be adopted in which four or more ECUs calculate the information on the control of the vehicle 20. It should be noted that not only a form may be adopted in which basic computation and extended computation are each performed in a physically different ECU, but also a form may be adopted in which the basic computation and the extended computation are shared in one ECU. Even in this case, it can be done. It should be noted that a form may be adopted in which an ECU is operated as a virtual machine in one ECU.

The form described in connection with FIG. 4 to FIG. 11 or the like has a configuration in which the first ECU 110 includes the operation amount calculation unit 115 and in which the delivery unit 118 delivers, to the core ECU 120, the operation amount calculated by the operation amount calculation unit 115 based on the first calculation result by the first calculation unit 114 or the operation amount calculated by the operation amount calculation unit 115 based on the second calculation result by the second calculation unit 214. As a variation of this form, a configuration may be adopted in which the core ECU 120 includes the operation amount calculation unit 115, and a configuration may be adopted in which the delivery unit 118 delivers one of the first calculation result by the first calculation unit 114 or the second calculation result by the second calculation unit 214 to the operation amount calculation unit 115 included in the core ECU 120.

It should be noted that, in the vehicle 20 described above, the control unit 30 including the second control apparatus 22 is assumed to be mounted outside the vehicle 20. However, a form may be adopted in which the control unit 30 is mounted in the vehicle 20. The control unit 30 may be shipped being incorporated in the vehicle 20.

The vehicle 20 described in this embodiment is one example of a transport device. A vehicle as one example of the transport device includes a four-wheeled automobile, a two-wheeled automobile, a saddle-riding type vehicle, or the like. The vehicle as one example of the transport device may be any type of vehicle such as a cart or a rail vehicle. The transport device can exemplify a device that transports at least one of a person and goods, such as a snowmobile, an agricultural machine, a ship, an aircraft including an unmanned aircraft, or the like.

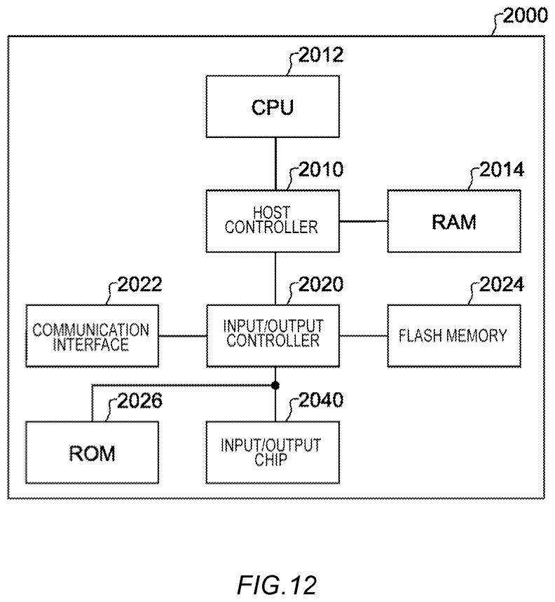

FIG. 12 shows an example of a computer 2000 in which a plurality of embodiments of the present invention may be wholly or partially embodied. A program installed in the computer 2000 can cause the computer 2000 to function as an apparatus such as the first control system and the second control system according to the embodiments or each unit of the apparatus, to execute operation associated with the apparatus or each unit of the apparatus, and/or to execute a process according to the embodiments or a step of the process. Such a program may be executed by a CPU 2012 in order to cause the computer 2000 to execute a specific operation associated with some or all of the processing procedures and the blocks in the block diagram described herein.

The computer 2000 according to this embodiment includes the CPU 2012 and RAM 2014, which are mutually connected by a host controller 2010. The computer 2000 also includes ROM 2026, a flash memory 2024, a communication interface 2022, and an input/output chip 2040. The ROM 2026, the flash memory 2024, the communication interface 2022 and the input/output chip 2040 are connected to the host controller 2010 via an input/output controller 2020.

The CPU 2012 operates according to the programs stored in the ROM 2026 and the RAM 2014, thereby controlling each unit.

The communication interface 2022 communicates with other electronic devices via a network. The flash memory 2024 stores the program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via an input/output port such as a serial port, a parallel port, a keyboard port, a mouse port, a monitor port, a USB port, or an HDMI (registered trademark) port.

The programs are provided via a network or a computer-readable storage medium such as a CD-ROM, a DVD-ROM, or a memory card. The RAM 2014, the ROM 2026, or the flash memory 2024 is an example of the computer-readable storage medium. The programs are installed in the flash memory 2024, the RAM 2014 or the ROM 2026, and are executed by the CPU 2012. Information processing written in these programs is read by the computer 2000, and provides cooperation between the programs and the various types of hardware resources described above. An apparatus or a method may be configured by realizing operation or processing of information according to a use of the computer 2000.

For example, when communication is performed between the computer 2000 and an external device, the CPU 2012 may execute a communication program loaded in the RAM 2014, and instruct the communication interface 2022 to execute communication processing, based on processing written in the communication program. The communication interface 2022, under control of the CPU 2012, reads transmission data stored in a transmission buffer processing region provided in a recording medium such as the RAM 2014 and the flash memory 2024, sends the read transmission data to the network, and writes reception data received from the network into a reception buffer processing region or the like provided on the recording medium.

Moreover, the CPU 2012 may cause all or a necessary portion of a file or a database stored in the recording medium such as the flash memory 2024 or the like, to be read by the RAM 2014, and execute various types of processing on the data on the RAM 2014. Then, the CPU 2012 writes back the processed data into the recording medium.

Various types of programs and various types of information such as data, a table, and a database may be stored in the recording medium, and subjected to information processing. The CPU 2012 may execute, on the data read from the RAM 2014, various types of processing including various types of operations, information processing, conditional judgement, conditional branching, unconditional branching, information retrieval/replacement, or the like described herein and specified by instruction sequences of the programs, and writes back the results into the RAM 2014. Moreover, the CPU 2012 may retrieve information in a file, a database, or the like in the recording medium. For example, when a plurality of entries, each having an attribute value of a first attribute associated with an attribute value of a second attribute, are stored in the recording medium, the CPU 2012 may retrieve, out of said plurality of entries, an entry with the attribute value of the first attribute specified that meets a condition, read the attribute value of the second attribute stored in said entry, and thereby acquire the attribute value of the second attribute associated with the first attribute meeting a predetermined condition.

The above-described programs or software module may be stored on the computer 2000 or in the computer-readable storage medium in the vicinity of the computer 2000. A recording medium such as a hard disk or RAM provided in a server system connected to a dedicated communication network or the Internet can be used as the computer-readable storage medium. The programs stored in the computer-readable storage medium may be provided to the computer 2000 via the network.

The program that is installed in the computer 2000 and that causes the computer 2000 to function as the first control system 100 may instruct the CPU 2012 or the like to cause the computer 2000 to function as each unit of the first control system 100. The information processing written in these programs are read by the computer 2000, thereby functioning as each unit of the first control system 100, which is a specific means realized by the cooperation of software and the various hardware resources mentioned above. Then, these specific means realize operations or processing of information corresponding to the intended use of the computer 2000 according to this embodiment, so that a specific control system corresponding to the intended use is constructed.

The program that is installed in the computer 2000 and that causes the computer 2000 to function as the second control system 200 may instruct the CPU 2012 or the like to cause the computer 2000 to function as each unit of the second control system 200. The information processing written in these programs are read by the computer 2000, thereby functioning as each unit of the second control system 200, which is a specific means realized by the cooperation of software and the various hardware resources mentioned above. Then, these specific means realize operations or processing of information corresponding to the intended use of the computer 2000 according to this embodiment, so that a specific control system corresponding to the intended use is constructed.

Various embodiments have been described with reference to the block diagram or the like. In the block diagram, each block may represent (1) a step of a process in which an operation is executed, or (2) each unit of the apparatus responsible for executing the operation. Specific steps and each unit may be implemented by a dedicated circuit, a programmable circuit supplied along with a computer-readable instruction stored on a computer-readable storage medium, and/or a processor supplied along with the computer-readable instruction stored on the computer-readable storage medium. The dedicated circuit may include a digital and/or analog hardware circuit, or may include an integrated circuit (IC) and/or a discrete circuit. The programmable circuit may include a reconfigurable hardware circuit including: logical AND, logical OR, logical XOR, logical NAND, logical NOR, and other logical operations; a memory element such as a flip-flop, a register, a field programmable gate array (FPGA), a programmable logic array (PLA), or the like; and so on.

The computer-readable storage medium may include any tangible device capable of storing an instruction executed by an appropriate device, so that the computer-readable storage medium having the instruction stored thereon constitutes at least a part of a product including an instruction that may be executed in order to provide a means to execute an operation specified by processing procedure or a block diagram. Example of the computer-readable storage medium may include an electronic storage medium, a magnetic storage medium, an optical storage medium, an electromagnetic storage medium, a semiconductor storage medium, or the like. More specific examples of the computer-readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disc (DVD), a Blu-ray (registered trademark) disc, a memory stick, an integrated circuit card, and the like.

The computer-readable instruction may include any of: an assembler instruction, an instruction-set-architecture (ISA) instruction; a machine instruction; a machine dependent instruction; a microcode; a firmware instruction; state-setting data; or either a source code or an object code written in any combination of one or a plurality of programming languages, including an object oriented programming language such as Smalltalk (registered trademark), JAVA (registered trademark), C++, or the like; and a conventional procedural programming language such as a “C” programming language or a similar programming language.

The computer-readable instruction may be provided to a general-purpose computer, a special-purpose computer, or a processor or a programmable circuit of another programmable data processing apparatus, locally or via a local area network (LAN), a wide area network (WAN) such as the Internet or the like, and the computer-readable instruction may be executed in order to provide a means to execute operations specified by the described processing procedure or the block diagram. Examples of the processor include a computer processor, processing unit, a microprocessor, a digital signal processor, a controller, a microcontroller, and the like.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

20: vehicle
18: controlled device
21: first control apparatus
22: second control apparatus
26: connection port
30: control unit
70: power supply
72: high-voltage battery
74: DC/DC converter
76: low-voltage battery
82: switch
84: DC/DC converter
86: battery
100: first control system
101: first sensor
102: front camera
104: radar
106: location sensor
110: first ECU
112: first sensor information acquisition unit
114: first calculation unit
116: calculation result acquisition unit
118: delivery unit
120: core ECU
115: operation amount calculation unit
130: ECU
140: ECU
180: controlled device
181: EPS
182: FT/MOT
183: ESB
184: SMART
186: IVI/MID
200: second control system
201: second sensor
202: front camera
204: surround camera
206: Lidar
210: second ECU
212: second sensor information acquisition unit
214: second calculation unit
218: operation amount calculation unit
280: controlled device
281: LVD
282: IND
283: VSA
284: SRS
285: EPS
710: normal processing
711: fail-safe processing
720: delivery determination processing
730: vehicle control
740: normal processing
741: fail-safe processing
750: vehicle control
1100: first control system
2000: computer
2010: host controller
2012: CPU
2014: RAM
2020: input/output controller
2022: communication interface
2024: flash memory
2026: ROM
2040: input/output chip

What is claimed is:

1. A mobile object control system mounted on a mobile object in which driver assistance control is executed based on information on a to-be-monitored object, the mobile object control system comprising
a first control system including a first processor configured to acquire information from at least one or more first sensors and to calculate first information on a to-be-monitored object from the acquired information, wherein
the first control system can deliver a calculation result of the first information to a second control system, wherein
the second control system includes a second processor configured to acquire information acquired from at least one or more second sensors different from the first sensors and to calculate second information on a to-be-monitored object based on the calculation result delivered from the first control system and information acquired from the second sensors.

2. The mobile object control system according to claim 1, wherein the first processor is further configured to:
acquire a calculation result of the second information; and
calculate an operation amount of the mobile object by using the calculation result of the first information or the calculation result of the second information.

3. The mobile object control system according to claim 1, wherein
when determining that the first control system has failed, the second processor is configured to perform calculation concerning a to-be-monitored object only based on the information acquired from the second sensors.

4. The mobile object control system according to claim 2, wherein
when determining that the second control system has failed, the first processor is configured to perform calculation concerning a to-be-monitored object only based on the information acquired from the first sensors and to calculate the operation amount by using a calculation result concerning the to-be-monitored object.

5. The mobile object control system according to claim 1, further comprising the second control system.

6. The mobile object control system according to claim 5, wherein
a power supply configured to supply electrical power to the second control system is mounted on one housing.

7. The mobile object control system according to claim 6, wherein
the second sensors are mounted on the housing.

8. The mobile object control system according to claim 6, wherein
the housing is mounted outside the mobile object.

9. The mobile object control system according to claim 2, wherein
the first processor and the second processor are configured to respectively acquire information from the first sensors and the second sensors according to a common synchronous signal supplied at a predetermined cycle, and
when the first control system has not acquired a calculation result of the second processor within one cycle of the synchronous signal, the first processor is configured to determine an operation amount by using the calculation result of the first information.

10. The mobile object control system according to claim 2, wherein
the first processor and the second processor are configured to respectively acquire information from the first sensors and the second sensors according to a common synchronous signal supplied at a predetermined cycle, and
when the second control system has not acquired the calculation result of the first information within one cycle of the synchronous signal, the second processor is configured to perform calculation concerning a to-be-monitored object only based on the information acquired from the second sensor, and the first processor is configured to determine an operation amount by using the calculation result of the second information.

11. The mobile object control system according to claim 2, wherein
the first processor is configured to acquire information from the first sensors according to a synchronous signal supplied at a predetermined cycle,
the second processor is configured to calculate information on a to-be-monitored object based on the calculation result of the first information delivered from the first control system and the information acquired by the second processor, according to an event signal generated when the first control system delivers a calculation result of the first processor, and to deliver a calculation result to the first control system,
when the first control system has not acquired the calculation result of the second information within one cycle of the synchronous signal, the first processor is configured to determine an operation amount by using the calculation result of the second information.

12. The mobile object control system according to claim 2, wherein
when determining that the first control system has failed, the second processor is configured to perform calculation concerning a to-be-monitored object only based on the information acquired from the second sensors.

13. The mobile object control system according to claim 2, further comprising the second control system.

14. The mobile object control system according to claim 13, wherein
a power supply configured to supply electrical power to the second control system is mounted on one housing.

15. The mobile object control system according to claim 4, wherein
the first processor and the second processor are configured to respectively acquire information from the first sensors and the second sensors according to a common synchronous signal supplied at a predetermined cycle, and
when the first control system has not acquired a calculation result of the second processor within one cycle of the synchronous signal, the first processor is configured to determine an operation amount by using the calculation result of the first information.

16. The mobile object control system according to claim 4, wherein
the first processor and the second processor are configured to respectively acquire information from the first sensors and the second sensors according to a common synchronous signal supplied at a predetermined cycle, and
when the second control system has not acquired the calculation result of the first information within one cycle of the synchronous signal, the second processor is configured to perform calculation concerning a to-be-monitored object only based on the information acquired from the second sensor, and the first processor is configured to determine an operation amount by using the calculation result of the second information.

17. The mobile object control system according to claim 4, wherein
the first processor is configured to acquire information from the first sensors according to a synchronous signal supplied at a predetermined cycle,
the second processor is configured to calculate information on a to-be-monitored object based on the calculation result of the first information delivered from the first control system and the information acquired by the second processor, according to an event signal generated when the first control system delivers a calculation result of the first processor, and to deliver a calculation result to the first control system,
when the first control system has not acquired the calculation result of the second information within one cycle of the synchronous signal, the first processor is configured to determine an operation amount by using the calculation result of the second information.

18. A mobile object control system mounted on a mobile object in which driver assistance control is executed based on information on a to-be-monitored object, the mobile object control system comprising
a second control system configured to acquire a first calculation result from a first control system for calculating the first calculation result concerning a to-be-monitored object from information acquired from at least one or more first sensors, wherein
the second control system includes a processor configured to acquire information acquired from at least one or more second sensors different from the first sensors and to calculate information on an to-be-monitored object based on the first calculation result and the information acquired from the second sensors, and
the second control system can deliver a calculation result of the information on the to-be-monitored object to the first control system.

19. A mobile object comprising the mobile object control system according to claim 1.

20. A control method by a mobile object control system mounted on a mobile object in which driver assistance control is executed based on information on a to-be-monitored object, the control method comprising:
acquiring, by a first control system, information from at least one or more first sensors;
calculating, by the first control system, information on a to-be-monitored object from the acquired information; and
delivering, by the first control system, a calculation result of the information on the to-be-monitored object to a second control system, wherein the second control system is configured to calculate information on a to-be-monitored object based on the delivered calculation result and information acquired from at least one or more second sensors different from the first sensors.
